(19) United States
(12) Patent Application Publication
(10) Pub. No.: US 2008/0247836 A1
(43) Pub. Date: Oct. 9, 2008

(54) METHOD AND APPARATUS FOR SECURING RECREATIONAL VEHICLES TO A TRAILER

(76) Inventors: Thomas Charles Erb, St. Paul, MN (US); Bruce Zierden, Melrose, MN (US)

Correspondence Address: SCHWEGMAN, LUNDBERG & WOESSNER, P.A., P.O. BOX 2938, MINNEAPOLIS, MN, 55402, US

(21) Appl. No.: 11/871,830

(22) Filed: Oct. 12, 2007

Related U.S. Application Data
(60) Provisional application No. 60/829,459, filed on Oct. 13, 2006.

(51) Int. Cl. B60P 3/073

(52) U.S. Cl. 410/7

(57) ABSTRACT

One embodiment of the present subject matter includes an apparatus for securing an ATV with a ball hitch to a transport having a transport surface and an eyelet. The embodiment includes an elongate housing having a length and a cantilever beam coupled to the elongate housing at a beam portion proximal to the elongate housing, the cantilever beam extending away from the elongate housing. The embodiment includes an elongate bolt extending through the elongate housing along the length of the elongate housing, the elongate bolt including threads which are adapted to screw to the eyelet of the transport, securing the elongate housing to the transport, and a hollow receiver connected to the cantilever beam at a beam portion distal to the elongate housing, the hollow receiver sized to receive a ball hitch.

### CROSS REFERENCE TO RELATED APPLICATIONS

This application claims the benefit of priority of the filing date of U.S. Provisional Application No. 60/829,459, filed on Oct. 13, 2006. The entire contents of which are incorporated herein by reference.

### TECHNICAL FIELD

This disclosure relates generally to trailering vehicles, and more specifically to method and apparatus for securing recreational vehicles to a trailer.

### BACKGROUND

Not all vehicles are suitable for traversing public roads. For example, many all train vehicles (“ATVs”) are not equipped to legally travel public roads. This presents a problem to ATV owners who want to use their ATVs in different parts of the country. For these people, one way to transport their ATV from one part of the country to another over public roads is by using a transport, such as a trailer.

But trailering ATVs is not easy. ATVs often have balloon tires and high-travel suspensions. These and/or other design features can make it difficult to secure an ATV to a trailer. Additionally, ATV users desire a quick way to secure an ATV to a trailer using limited extra equipment. Solutions to these problems should be robust and inexpensive, as ATV users desire long lasting, reliable solutions at an affordable price.

### SUMMARY

One embodiment of the present subject matter includes an apparatus for securing an ATV with a ball hitch to a transport having a transport surface and an eyelet. The embodiment includes an elongate housing having a length. The embodiment additionally includes a cantilever beam coupled to the elongate housing at a beam portion proximal to the elongate housing, the cantilever beam extending away from the elongate housing. The embodiment includes an elongate bolt extending through the elongate housing along the length of the elongate housing, the elongate bolt including a threaded portion having threads, the threads being adapted to screw to the eyelet of the transport. The embodiment additionally includes a hitch receiver connected to the cantilever beam at a beam portion distal to the elongate housing, the hitch receiver having an opening sized to receive the ball hitch which is oriented in the direction of the threaded portion of the elongate bolt.

One embodiment of the present subject matter includes a method for securing an ATV having a suspension and a ball hitch to a transport having a threaded eyelet. The embodiment includes aligning the ATV with a receiver on that transport. The embodiment includes fitting a hollow receiver over the ball hitch, the hollow receiver being connected to an elongate housing. The embodiment includes threading an elongate bolt through the elongate housing and into the threaded eyelet. The embodiment includes tightening the elongate bolt such that the hollow receiver is forced toward the transport, compressing the suspension of the ATV.

One embodiment of the present subject matter includes an apparatus for securing an ATV with a ball hitch to a transport having a transport surface and an eyelet. The embodiment includes receiver means for receiving a ball hitch. The embodiment includes an elongate housing connected to the receiver means. The embodiment additionally includes fastener means threaded through the elongate housing, the fastener means for compressing the receiver means toward the transport to secure the ATV to the transport.

Various options are contemplated by the present subject matter. Some embodiments are contemplated in which the elongate housing has a first portion oriented toward the eyelet of the transport and further comprising stabilizer feet extending away from the first portion of the elongate housing and along the transport. Embodiments are contemplated in which the cantilever beam is bolted with adjustment bolts to one of a series of apertures in the elongate housing, with each of the series of apertures sized to receive the adjustment bolts. Embodiments are contemplated in which the elongate housing has a substantially square cross section. Embodiments are contemplated in which the hollow receiver is a cylinder. Embodiments are contemplated in which the bolt is threaded with worm drive threads. Embodiments are contemplated in which the bolt has a handle sized for grasping by a substantially average adult human. Embodiments are contemplated in which the elongate housing includes an aperture through which the elongate bolt passes, and the elongate bolt includes a flange which is larger than the aperture of the elongate housing. Embodiments are contemplated in which the flange includes a first lock pin aperture, and the elongate housing includes a second lock pin aperture, and a lock pin is adapted to lock the first lock pin aperture to the second lock pin aperture. Embodiments are contemplated which include a plate connected to the elongate bolt, sandwiching the transport between the plate and stabilizer feet which are connected to the elongate housing and extend away from the elongate housing at the base of the elongate housing. Embodiments are contemplated which include U-Bolts connecting the eyelet to a cross member of the transport. Embodiments are contemplated in which the eyelet is welded to a cross member of the transport. Embodiments are contemplated which include locking the position of the elongate bolt with a lock pin. Embodiments are contemplated in which the suspension is balloon tires. Embodiments are contemplated in which the suspension includes springs. Embodiments are contemplated which include adjusting the position of the hollow receiver with respect to the elongate housing to adjust the level of compression of the suspension when the ATV is secured to the transport. Embodiments are contemplated which include lock means for locking the position of the fastener means with respect to the receiver means. Embodiments are contemplated in which the fastener means include an elongate bolt.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their legal equivalents.

### BRIEF DESCRIPTION OF THE DRAWINGS

FIG. 1A illustrates a clamp, an ATV, and a trailer in an ATV unclamped state, according to one embodiment of the present subject matter.

FIG. 1B illustrates a clamp, an ATV, and a trailer in an ATV clamped state, according to one embodiment of the present subject matter.

FIG. 2A illustrates a top view of an elongate housing, stabilizing feet, and a hitch receiver, according to one embodiment of the present subject matter.

FIG. 2B illustrates a top view of an elongate housing, stabilizing feet, and a hitch receiver, according to one embodiment of the present subject matter.

FIG. 2C illustrates a top view of an elongate housing, stabilizing feet, and a hitch receiver, according to one embodiment of the present subject matter.

FIG. 3 illustrates an elongate bolt, according to one embodiment of the present subject matter.

FIG. 4 is a partial cross section of a cantilever beam, according to one embodiment of the present subject matter.

FIG. 5 is a perspective view of a trailer, an ATV, and a clamp, according to one embodiment of the present subject matter.

FIG. 6 is a perspective view of the back of an ATV, a trailer, and a clamp, according to one embodiment of the present subject matter.

FIG. 7A shows a perspective view of a clamp for securing an ATV to a trailer using a first cap head bolt and a second cap head bolt, according to one embodiment of the present subject matter.

FIG. 7B show another perspective view of the clamp in FIG. 7B.

FIG. 7C show a partial perspective view of the clamp in FIG. 7B, sectioned at the line 7C-7C.

FIG. 8 shows a clamp for securing an ATV to a trailer using a first bolt and a second bolt, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter provides a simple, robust, and inexpensive solution to securing an ATV to a transport such as a trailer. Embodiments of the present subject matter provide a clamp which screws to an eyelet of a trailer, the clamp introducing a compressive load into the ATV's suspension by pressing on the hitch of the ATV.

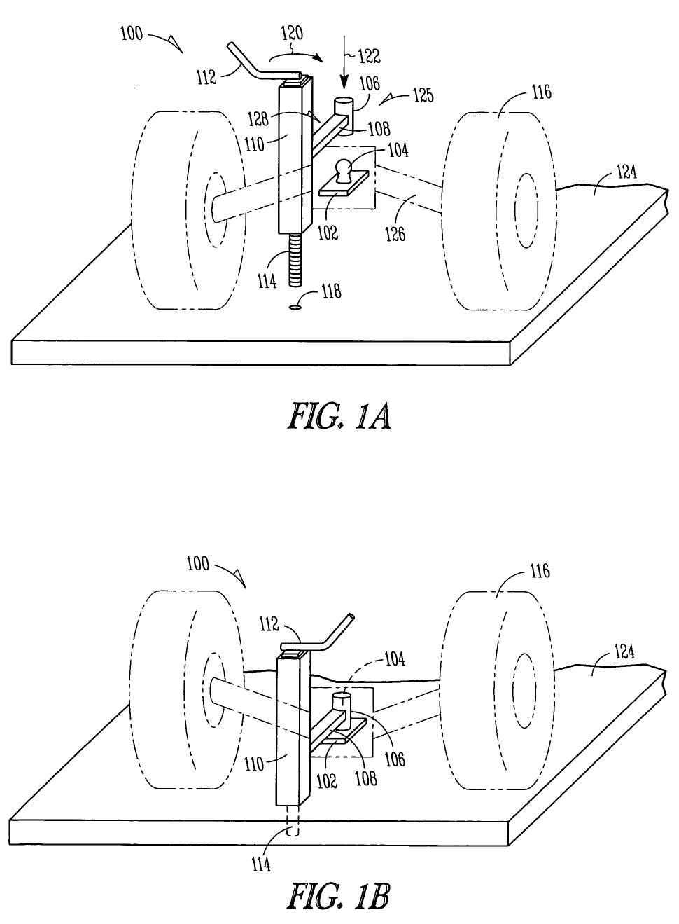

FIG. 1A illustrates a clamp, an ATV, and a trailer in an ATV unclamped state, according to one embodiment of the present subject matter. FIG. 1B illustrates a clamp, an ATV, and a trailer in an ATV clamped state, according to one embodiment of the present subject matter. In various embodiments, the clamp 100 includes an elongate housing 110, through which an elongate bolt 114 travels. In various embodiments, the elongate housing is connected to a cantilever beam 108 at a proximal portion 128 of the cantilever beam. In various embodiments, a hitch receiver 106 is coupled to the cantilever beam 108 at a distal portion 125 of the cantilever beam 108.

In various embodiments, the clamp assembly 100 includes a handle 112 which turns a threaded section of the bolt 114. The threaded section of the bolt 114 is adapted to thread into an eyelet 118 of a transport surface 124. Transport surfaces contemplated by the present subject matter include, but are not limited to, trailer surfaces. In various embodiments, the elongate bolt 114 has a handle 112 sized for grasping by a substantially average adult human.

As the handle 112 is turned 120, in various embodiments, the clamp assembly 100 travels 122 toward the transport surface 124. In various embodiments, the hitch receiver 106 fits over the ball hitch 104. In various embodiments, the ball hitch 104 is mounted to a hitch tongue 102 of the ATV. The hitch receiver 106 is a cylindrical tube in some embodiments of the present subject matter, but is not so limited, as the present subject matter additionally contemplates hitch receivers which do not include a passageway which extends through the hitch receiver.

In various embodiments, the suspension 126 is compressed as the clamp 100 is tightened from an unclamped state to a clamped state. FIG. 1A illustrates one embodiment of a clamped state. FIG. 1B illustrates one embodiment of an unclamped state. In various embodiments, the tires 116 provide a spring in the system illustrated. In some embodiments, the tires 116 additionally provide a portion of the suspension which is compressed when the clamp is tightened from an unclamped state to a clamped state.

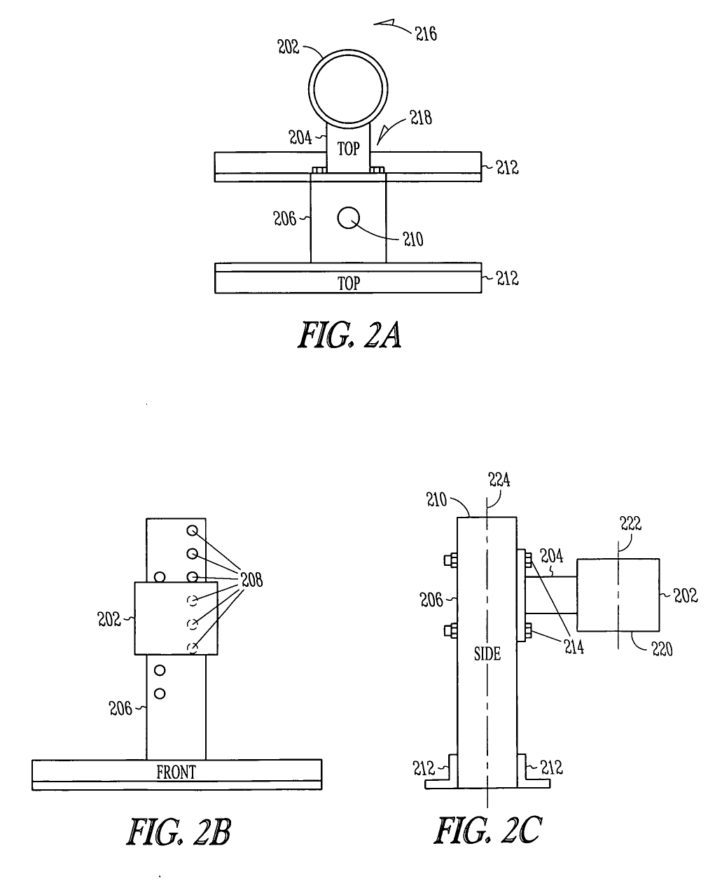

FIGS. 2A-C illustrate an elongate housing, stabilizing feet, and a hitch receiver, according to one embodiment of the present subject matter. Pictured in the illustrations are stabilizer feet 212, hitch receiver 202, cantilever beam 204, and elongate housing 206. Additionally pictured is an aperture 210 in the elongate housing 206. In various embodiments, a threaded bolt is sized to pass through the aperture 210. In some embodiments, a threaded bolt includes a flange which prevents the threaded bolt from passing entirely through the aperture 210.

Pictured are a plurality of apertures 208 through which adjustment bolts 214 are adapted to pass. In some embodiments, two bolts are used diagonal to one another across the cantilever beam 204 instead of four bolts forming a square around cantilever beam 214, but the subject matter is not so limited. Configurations using four bolts are additionally contemplated by the present subject matter. Although the present subject matter illustrates a bolt and nut combination for connecting the cantilever beam 204 to the elongate housing 206, the present subject matter is not so limited, and includes, but is not limited to, nuts welded to the elongate housing 206, and welding the cantilever beam 204 to the elongate housing 206.

In the pictured illustrations, the hitch receiver 202 is connected to the cantilever beam 204 at a beam portion 216 distal to the elongate housing and opposed to a proximal portion 218 of the housing. In various embodiments, the hitch receiver 202 has an opening 220 sized to receive the ball hitch which is oriented in the direction of the threaded portion of the elongate bolt. In various embodiments, the opening 220 opens toward the threaded portion of an elongate bolt mated to the elongate housing.

In various embodiments, the hitch receiver has a center axis 222 which is substantially parallel with a center axis 224 of the elongate housing. In embodiments, the center axis 224 of the elongate housing 206 is substantially coincident with the center axis of an elongate bolt which extends through the length of the elongate housing 206.

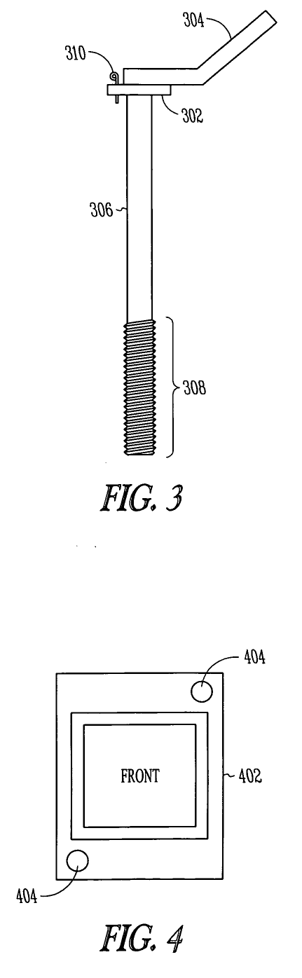

FIG. 3 illustrates an elongate bolt, according to one embodiment of the present subject matter. In various embodiments, the elongate bolt 306 includes a threaded portion 308. Screw thread configurations contemplated by the present subject matter include, but are not limited to, sharp v, unified, modified square, acme, stub acme, worm, knuckle and other screw thread types not recited herein expressly.

Embodiments of the present subject matter includes a handle 304 coupled to the elongate bolt 306, although the present subject matter is not so limited, and includes elongate bolts having other heads including, but not limited to, cap heads, hex heads, heads having knobs for hand turning, and other heads not herein expressly described.

The present subject matter, in various embodiments, includes a locking pin 310 which is adapted to lock flange 302 in position with respect to an elongate housing to which the elongate bolt 306 is mated. For example, in various embodiments, the flange 302 includes a first lock pin aperture, and the elongate housing includes a second lock pin aperture, and a lock pin 310 is adapted to lock the first lock pin aperture to the second lock pin aperture.

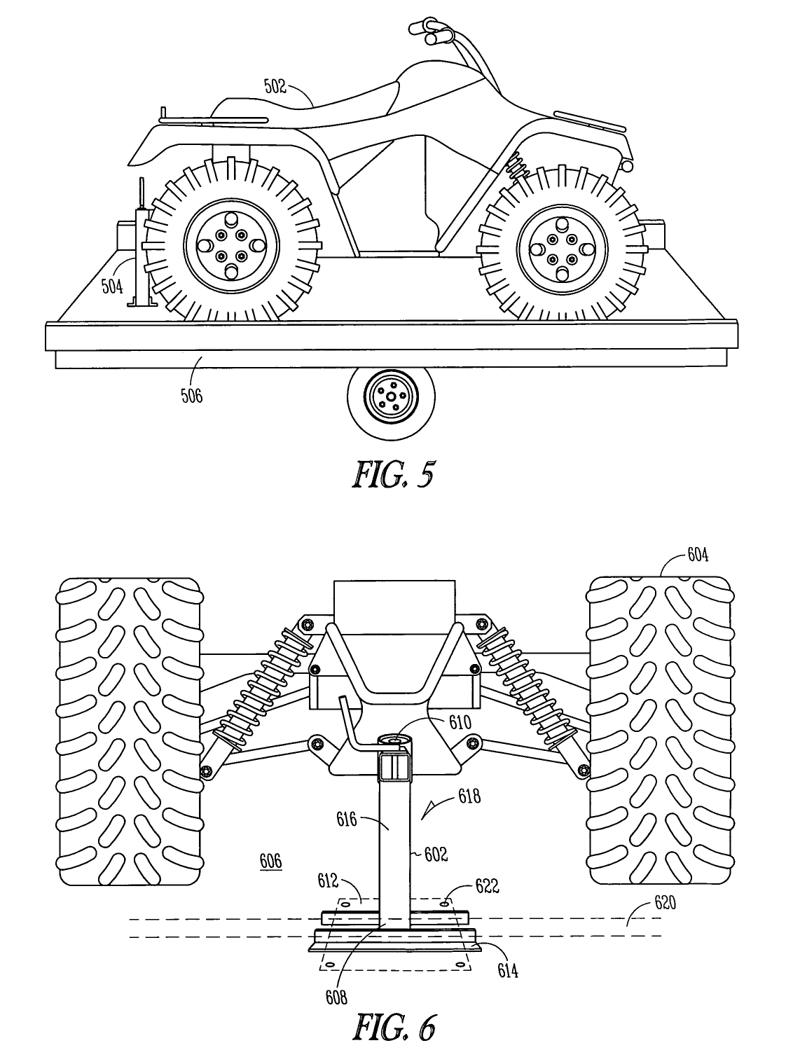

FIG. 4 is a partial cross section of a cantilever beam, according to one embodiment of the present subject matter. Two holes 404 diagonal from one another across the cantilever beam 402 are illustrated. Although the cross section shows that the cantilever beam has a substantially square shape, the present subject matter contemplates additional shapes, such as circles, ellipses, rectangles, and other shapes not listed herein expressly.

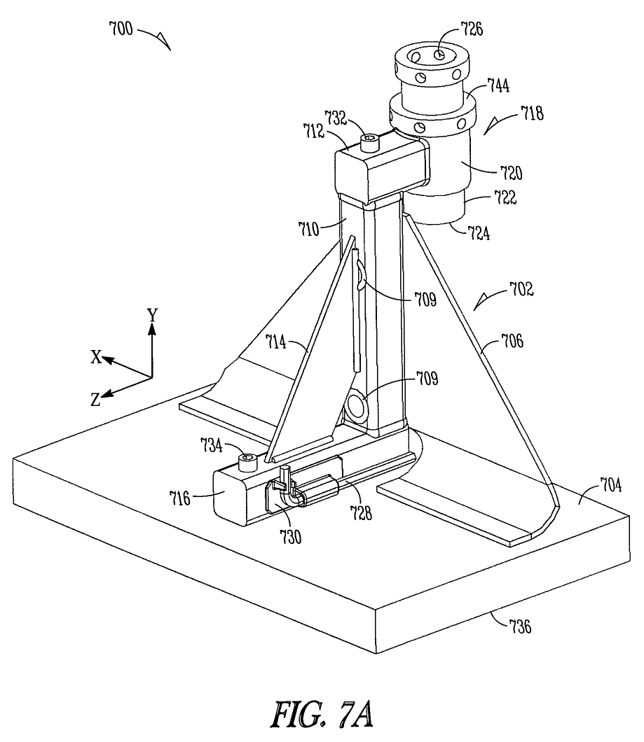

FIG. 5 is a perspective view of a trailer, an ATV, and a clamp, according to one embodiment of the present subject matter. The picture illustrated shows a four wheeled ATV. The present subject matter includes, but is not limited to, four wheeled ATVs, as wheel as three wheeled ATVs, and other variants.

Illustrated are a trailer 506, an ATV, and a clamp 504 for securing the ATV 502 to the trailer 506, according to various embodiments of the subject matter. Various ATV suspensions are contemplated by the present subject matter.

ATVs having solid axle suspensions are contemplated by the present subject matter. In some embodiments adapted to secure ATVs having solid axle suspensions, the present subject matter compresses the tires of the ATV against a trailer, thereby securing the ATV to the trailer.

ATVs having independent suspensions are contemplated by the present subject matter. In some embodiments adapted to secure ATVs having solid axle suspensions, the present subject matter compresses one or both of the tires of the ATV and the suspension of the ATV against a trailer, thereby securing the ATV to the trailer.

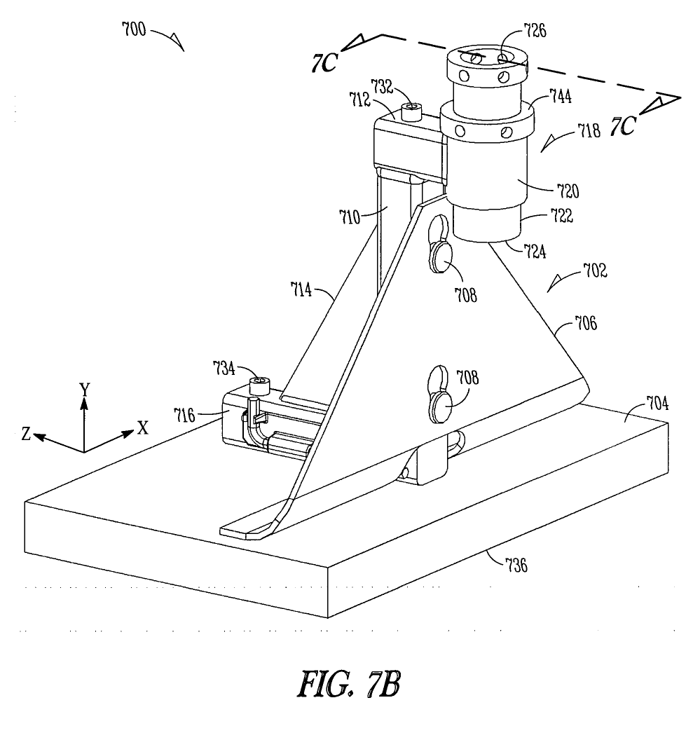

FIG. 6 is a perspective view of the back of an ATV, a trailer, and a clamp, according to one embodiment of the present subject matter. Illustrated are ATV 604, trailer 606, and clamp 618. The illustration shows one embodiment of the present subject matter which does not include a plurality of holes and adjustment bolts for adjusting the distance between the hitch receiver and the base 608 of the elongate housing. ATV with independent suspension. The hitch receiver in the pictured embodiment is a cylinder, which fits over a ball hitch 610. The subject matter of the present application is no limited to cylinder embodiments of the hitch receiver, and other embodiments are additionally contemplated.

The illustration additionally shows a plate 612 connected to the elongate bolt, sandwiching the transport 606 between the plate and the stabilizer feet 614. In various embodiments, the stabilizer feet 614 are connected to the elongate housing 618 and extend away from the elongate housing at the base 608 of the elongate housing 602. In optional embodiments, U-bolts 622 secure the clamp 616 to a cross member 620. Additional embodiments which secure an eyelet to the trailer 606 are contemplated, such as those in which an eyelet is welded to cross member 620.

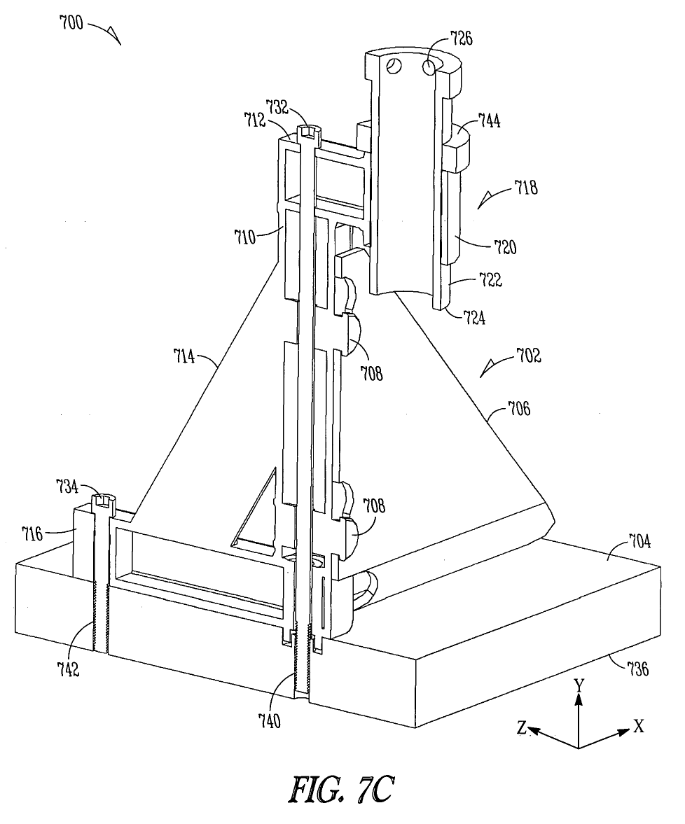

FIGS. 7A-7C show a clamp for securing an ATV to a trailer using a first cap head bolt and a second cap head bolt, according to one embodiment of the present subject matter. Illustrated is a clamp 702 for mounting to a transport surface 704. The clamp 702 includes a lateral support gusset 706. The lateral support gusset 706 is shown locked to pegs 708. The lateral gusset 706 is shown abutting, but not coupled to, the transport surface 704. In additional embodiments, the lateral gusset 706 is coupled to the transport surface. Although pegs are used, in additional embodiments other fasteners could be substituted for the pegs 708, or could be used in combination with the pegs 708. Such fasteners include bolts, welds, etc. Welds 709 are shown. The illustrated construction bores a hole into the elongate housing 710, inserts the pegs through the elongate housing 710, and welds the pegs to the elongate housing 710 at welds 709.

The pegs 708 shown are coupled to an elongate housing 710. The elongate housing 710 can be a square tube as shown. Round tubes, beams, and other structures are possible in additional embodiments of elongate housing 710. A variety of materials are possible for the elongate housing 710, such as aluminum and its alloys, and steel and its alloys including chromium-molybdenum alloys and stainless steels.

In various embodiments, elongate housing 710 is coupled to a cantilevered beam 712. In some embodiments the cantilevered beam 712 is coupled to the elongate housing 710 with a weld, and in additional embodiment other fasteners are used alone or in combination with a weld, such as a flange coupled to the cantilever beam 712 and bolted to the elongate housing 710, or vice versa. In various embodiments, the cantilever beam 712 is coupled to the elongate housing approximately perpendicular to the elongate housing 710. The cantilever beam 712 can be a square tube in some embodiments, but in additional embodiments it is a beam such as an I-beam, a round tube, a solid cylinder, or another type of beam which resists bending. In some I-beam configurations, for example, the center web of the I-beam would be approximately coplanar with the longitudinal gusset 714.

The longitudinal gusset 714, in various embodiments, is coupled to a base beam 716. In various embodiments the base beam 716 is elongate and has a length is parallel to a length of an elongate cantilever beam 712, but the present subject matter is not so limited. The base beam 716, in various embodiments, is coupled to the elongate beam 710, such as by welding or bolts.

The clamp 700 also includes a hitch receiver 718. The hitch receiver includes an outer barrel 720 that is male and includes inner threads. The hitch receiver also includes an inner barrel 722 that is adjustable and that includes threads such that it can thread into the outer barrel 720. The inner barrel 722 receives a ball hitch and includes a contact surface 724 that can abut a hitch to which a ball hitch is mounted. It can also abut a flange of a ball hitch. As such, the

The hitch receiver 718 in various embodiments includes a lumen sized to receive a ball hitch, in some examples. The lumen, in various embodiments, is sized to constrain a ball hitch from moving along one or more vectors in the X-Z plane. This can be via an interference fit, or a fit of a small tolerance. Other embodiments include a loose fit such as to accommodate multiple ball hitch sizes.

The inner barrel 722 screws into the outer barrel 720 to clamp an ATV ball hitch against a transport surface, such as the load surface of a trailer or of a pickup truck. The inner barrel is shown with adjustment holes 724 such as to receive a spanner wrench or the hex wrench 728. The hex wrench can optionally be coupled to the base beam 716 with a hex wrench holder 730. The hex wrench holder can couple to the base beam 716 with an adhesive, such as double sticky tape, or with a mechanical fastening means, such as “harpoons” or “Christmas trees” coupled to one or more apertures in the base beam 716.

An elongate bolt 732 is pictured extending through the elongate housing 710, as described herein. An additional fastener coupling the clamp 700 to the transport surface 704 is a base beam bolt 734. These bolts can be cap head, hex head, or have another design. Each of the elongate bolt 732 and the base beam bolt 734 and their respective eyelets can be interchanged with other fastener designs, such as key-slot designs. Some embodiments include a key-slot design which allows an operator to insert a key of the elongate bolt 732 into a slot, turn it 90 degrees, and have it lock into position. Safety wire or other locks can optionally be used to secure the position of one or more of the elongate bolt 732 and the base beam bolt 734.

The clamp 700, in one mode of operation, is first adjusted for fitment to an ATV by adjusting the inner barrel 722 with respect to the outer barrel 720 along the Y axis. An optional lock nut 744 is shown which can be tightened against the outer barrel 720 to restrict further adjustment of the inner barrel 722. The lock nut can be a spanner design, or it can be a hex design, a finger or hand tightenable design, or another design. A hand tightenable design could include knurling, in some examples.

The clamp is fastened to the transport surface. The present subject matter secures an ATV to the transport surface 736 by tightening one or more of the elongate bolt 732 and the base beam bolt 734. This moves the clamp along the Y axis and clamps a ball hitch toward the transport surface 736. Such tightening can compress the suspension of the ATV, in some embodiments. Such ATV suspension, in various examples, includes just tires, or tires and springs/dampers, as is known. A quick release function of the clamp 700 is that a user can release the elongate bolt 732 and the base beam bolt 734 from their mating anchors, such as a threaded eyelet of the transport surface, to release the ATV. Such a benefit also allows the ATV to drive over the area of the transport surface 704 used to secure the ATV.

The present subject matter can be fitted to a transport surface by simply drilling one or more holes in the transport surface, and coupling an eyelet for mating to at least the elongate bolt 732 to the transport surface, such as by welding the eyelet to a sturdy portion of the transport surface. A sturdy portion of a wooden trailer would include a metal structural cross beam, in some embodiments. If the transport surface 736 is metallic, some embodiments could weld an eyelet such as a bolt to that surface.

Some embodiments create an eyelet by sandwiching a transport surface between two flanges which are coupled to one another, such as when an operator bores at least a first hole 740 in a transport surface through which the elongate bolt 732 could pass, and further bores holes such that a top flange can bolt to a bottom flange, with the bottom flange facing a bottom surface 736 and the top flange facing the top surface 738. A second hole 742 can optionally be bored. An eyelet is coupled to the bottom flange in some designs. An eyelet is welded to the flange, for example.

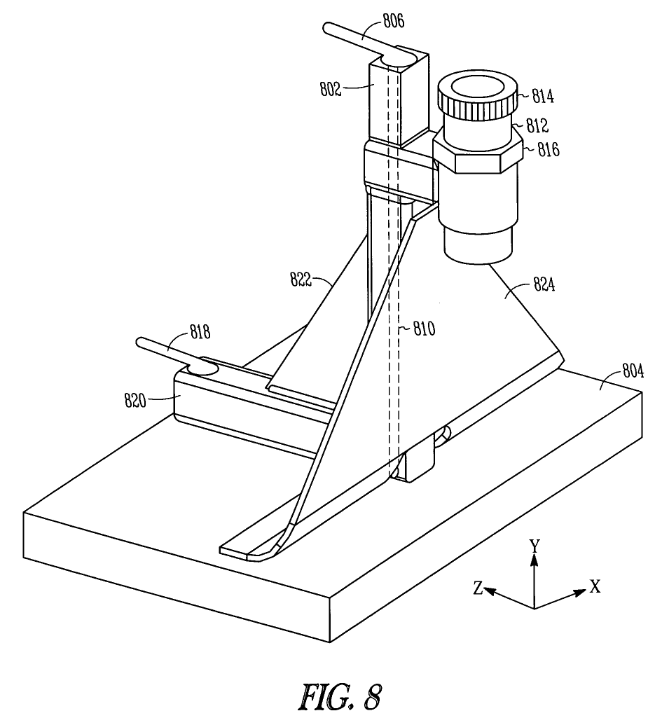

FIG. 8 shows a clamp for securing an ATV to a trailer using a first bolt and a second bolt, according to one embodiment of the present subject matter. An elongate housing 802 is shown which extends in the Y direction, away from and perpendicular to the transport surface 804 such that an elongate bolt handle 806 of an elongate bolt 810 can rotate without interfering with an inner barrel 812 hitch receiver. The inner barrel 812 is shown with a hand tightenable surface. A lock nut 816 having a hex design is used. A base beam bolt handle 818 is pictured. The base beam 820 is extended perpendicularly away form the elongate housing 802 far enough so that the base beam bolt handle 818 can rotate without contacting the longitudinal gusset 822. The lateral gusset 824 is shown welded to the elongate housing 802 in the embodiment.

Various methods are contemplated by the present subject matter. Some embodiments include methods for securing an ATV having a suspension and a hitch to a transport having an eyelet. In various embodiments, the eyelet is threaded. Additionally, some embodiments include a ball hitch. Some embodiments include aligning the ATV with a receiver on that transport. Some embodiments include fitting a hollow receiver over the ball hitch. In some of these embodiments, a hollow receiver is shaped like a cup. In some of these embodiments, the hollow receiver is shaped like a cylinder. In various embodiments, the hollow receiver being connected to an elongate housing.

Embodiments contemplated by the present subject matter include threading an elongate bolt through the elongate housing and into the threaded eyelet. Some embodiments include tightening the elongate bolt such that the hollow receiver is forced toward the transport. In some of these embodiments, the tightening includes compressing the suspension of the ATV. Some of these embodiments contemplate hand tightening, while other embodiments use other tightening procedures.

Some embodiments of the present subject matter include locking the position of the elongate bolt with a lock pin. Some embodiments are contemplated wherein the suspension is balloon tires. Embodiments are contemplated wherein the suspension includes springs.

Embodiments are contemplated which include adjusting the position of the hollow receiver with respect to the elongate housing to adjust the level of compression of the suspension when the ATV is secured to the transport.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. An apparatus for securing an ATV with a ball hitch to a transport having a transport surface and an eyelet, comprising:
an elongate housing having a length;
a cantilever beam coupled to the elongate housing at a beam portion proximal to the elongate housing, the cantilever beam extending away from the elongate housing;
an elongate bolt extending through the elongate housing along the length of the elongate housing, the elongate bolt including a threaded portion having threads, the threads being adapted to screw to the eyelet of the transport; and
a hitch receiver connected to the cantilever beam at a beam portion distal to the elongate housing, the hitch receiver having an opening sized to receive the ball hitch which is oriented in the direction of the threaded portion of the elongate bolt.

2. The apparatus of claim 1, wherein the elongate housing has a first portion oriented toward the eyelet of the transport and further comprising at least one lateral gusset extending away from the first portion of the elongate housing and along the transport.

3. The apparatus of claim 1, wherein the cantilever beam is welded to the elongate housing.

4. The apparatus of claim 1, wherein a base beam is coupled to the elongate housing and extends substantially perpendicularly away from the elongate housing along and adjacent to the transport surface.

5. The apparatus of claim 4, wherein a longitudinal gusset couples the elongate base beam to the elongate housing.

6. The apparatus of claim 4, further comprising a base beam bolt to extend through the base beam to couple the base beam to the transport surface.

7. The apparatus of claim 1, wherein the hitch receiver is a cylinder.

8. The apparatus of claim 1, wherein the elongate bolt includes a handle sized to be grasped by an average adult human.

9. The apparatus of claim 1, wherein the elongate housing includes an aperture through which the elongate bolt passes, and the elongate bolt includes a flange which is larger than the aperture of the elongate housing.

10. The apparatus of claim 8, wherein the flange includes a first lock pin aperture, and the elongate housing includes a second lock pin aperture, and a lock pin is adapted to lock the first lock pin aperture to the second lock pin aperture.

11. The apparatus of claim 1, wherein the hitch receiver includes an outer barrel coupled to the cantilever beam and an inner barrel threaded into the outer barrel such that that inner barrel is height adjustable with respect to the transport surface.

12. The apparatus of claim 1, wherein the eyelet is welded to a cross member of the transport.

13. A method for securing an ATV having a suspension and a ball hitch to a transport having a threaded eyelet, comprising:
aligning the ATV with a receiver on that transport;
fitting a hollow receiver over the ball hitch, the hollow receiver being connected to an elongate housing;
threading an elongate bolt through the elongate housing and into the threaded eyelet; and
tightening the elongate bolt such that the hollow receiver is forced toward the transport, compressing the suspension of the ATV.

14. The method of claim 13, further comprising locking the position of the elongate bolt with a lock pin.

15. The method of claim 13, wherein the suspension is balloon tires.

16. The method of claim 13, wherein the suspension includes springs.

17. The method of claim 13, further comprising adjusting the position of the hollow receiver with respect to the elongate housing to adjust the level of compression of the suspension when the ATV is secured to the transport.

18. An apparatus for securing an ATV with a ball hitch to a transport having a transport surface and an eyelet, comprising:
receiver means for receiving a ball hitch;
an elongate housing connected to the receiver means; and
fastener means threaded through the elongate housing, the fastener means for compressing the receiver means toward the transport to secure the ATV to the transport.

19. The apparatus of claim 18, further comprising lock means for locking the position of the fastener means with respect to the receiver means.

20. The apparatus of claim 18, wherein the fastener means include an elongate bolt.
